(19) United States
(12) Patent Application Publication
(10) Pub. No.: US 2006/0044999 A1
(43) Pub. Date: Mar. 2, 2006

(54) Information recording medium, driving apparatus for the same and method for recording secondary information of information recording medium

(75) Inventors: Tamotsu Iida, Ibaraki-shi (JP); Yuji Yamazaki, Ibaraki-shi (JP)

Correspondence Address: OLIFF & BERRIDGE, PLC, P.O. BOX 19928, ALEXANDRIA, VA, 22320, US

(73) Assignee: HITACHI MAXELL, LTD., Ibaraki-shi (JP)

(21) Appl. No.: 11/115,228

(22) Filed: Apr. 27, 2005

(30) Foreign Application Priority Data
Apr. 28, 2004 (JP) 2004-133689

(51) Int. Cl. G11B 7/24

(52) U.S. Cl. 369/275.3; 369/275.1; 369/272.1

(57) ABSTRACT

An information-recording medium is provided, which comprises a logical block recorded with secondary information and including an address information area, wherein the secondary information is recorded by inverting the phase of a fixed pattern including, for example, a synchronization signal or a resynchronization signal recorded in the logical block. Those used as the pattern for recording the secondary information are fixed patterns including, for example, a wobble pattern, a pit pattern, a recording pattern, and a domain pattern. Therefore, no trouble arises in the reproducing operation of a medium-driving apparatus.

### BACKGROUND OF THE INVENTION

1. Field of the Invention

The present invention relates to an information recording medium, a driving apparatus for the same, and a method for recording secondary information of the information-recording medium. In particular, the present invention relates to an information-recording medium on which secondary information including, for example, management information required to drive the information-recording medium is recorded, a driving apparatus for the same, and a method for recording secondary information.

2. Description of the Related Art

In the field of the information-recording medium, especially in the field of optical disks and hard disks, the structure of the track format becomes complicated as the information of the recording medium progressively has the high density. In many cases, different formats are adopted not only for the data-recording section but also for the management information area for driving with the drive.

In general, the optical disk has such a structure that the management information area, which includes the management information and which is disposed on the inner circumferential side of the optical disk, is provided, and the user information area, which includes the user information and which is disposed on the outer side of the management information area, is provided. This structure is generally adopted for the optical disk such as DVD-RAM of the type on which the information is recorded from the inner circumferential side of the disk. In the case of the optical disk of the type on which the information is recorded from the outer circumferential side of the disk, the management information area is formed on the outer circumferential side. There is also such an optical disk that the control track areas (areas in which the management information is recorded) are provided on both of the inner circumferential side and the outer circumferential side, although the areas are not referred to as the management information area.

Various proposals have been made to record, in the optical disk, the inherent information on the optical disk or the inherent information on the information to be recorded on the optical disk in view of the protection of the information to be recorded on the optical disk and/or the prevention of any imitation of the optical disk. For example, Japanese Patent No. 3042780 suggests a method for recording security data by using barcode information disposed at an inner circumferential portion of a disk. Further, for example, there are suggested a method for recording inherent information on an optical disk or inherent information on information to be recorded on the optical disk in a master disk process of the process for producing the optical disk, and a method for recording the information as described above afterward on an optical disk added with a recording film or a reflective film.

In general, the technical information of the area to be subjected to the reproduction of information with a driving apparatus is described in detail in a physical specification which is described, for example, with the format to be prepared in order to secure the interchangeability. The technical information is necessary minimum to record and reproduce the data. The contents of the information on the security, which are included in the technical information, are not disclosed. The information on the security is provided to protect the recording information, which is not necessarily required for the physical recording and reproduction on the medium, and which can be optionally adopted. In other words, the following basic concept is affirmed. That is, the information to secure the security is not necessarily required for the recording and reproduction on the medium, and hence the presence of the information to secure the security should not cause any trouble on the specification. Further, those which should not cause any trouble on the recording and reproduction of other information (for example, address information and user information) are not limited to the information on the security, which also include information other than the user data (main data or primary data) (such information will be hereinafter referred to as “secondary information”) exemplified, for example, by the archive information on the user data, the management information, the identification information on the contents, the reference information such as the explanation of the contents and the web address, the name of the copyright owner, and the established date of the copyright. Those information required for the recording and reproduction of information, which are included in the secondary information, are, for example, the secondary information in relation to the reproduction of the user information subjected to the security protection. The secondary information as described above has such a feature that the copyright protection is achieved.

However, as described in Japanese Patent No. 3042780, when the security information is recorded by using the barcode information on the inner circumferential portion of the disk, the data of the security information and the data of the user information are recorded by the means which are physically different from each other. Therefore, a problem arises such that the security data and the user information data can be distinguished with ease from the signal information even from the outside of the drive.

The identification information, which is used to identify the attribute of the medium and which is included in the secondary information contained in the information recording medium, includes the information, for example, on the name of the manufacturer and the identification code of the manufacturer in order to guarantee the medium reliability of the manufacturer. In recent years, a case has happened, in which any third party unjustly uses the identification code to supply the media to the market. The identification code is inherent in the manufacturer. Therefore, if media, which use any forged identification code, are supplied to the market, a problem arises such that the confidence of the manufacturer is deteriorated. Therefore, at present, an information-recording medium is demanded, which has such a structure that the inherent data of the medium including the identification code, the trademark code, and other information cannot be forged with ease.

### SUMMARY OF THE INVENTION

The present invention has been made in order to solve the problems as described above. A first object of the present invention is to provide an information-recording medium which can be easily identified in only a drive and secondary information of the medium cannot be replicated with ease. Further, the object of the present invention is to provide an information-recording medium which has such a structure that any secondary information in relation to the security cannot be recorded on a write-once medium even when the secondary information in relation to the security for any copy medium is obtained from any driving apparatus.

A second object of the present invention is to provide an information-recording medium and a driving apparatus therefor which make it possible to record secondary information of the information-recording medium even in an user information area including user information and which make it possible to perform ordinary recording and reproducing operation irrelevant to the presence or absence of the secondary information on the track in the user information area. In the present invention, a difference in specified recording pattern is detected when the secondary information is reproduced from the medium on which the secondary information has been recorded, as described later on. Therefore, the information-recording medium and the driving apparatus therefor of the present invention are such an information-recording medium and a driving apparatus that the specified recording pattern is selected as a pattern to effect the operation without any trouble for the original function of the pattern and the difference in the pattern can be detected as the secondary information.

Further, a third object of the present invention is to provide an information-recording medium which makes it possible to add the security to user information by adding secondary information even when the user information, which is restricted for the number of times of copy or movement, is subjected to the reproduction after the recording on the information-recording medium such as a hard disk, for example, via a digital communication line or an optical disk.

According to a first aspect of the present invention, there is provided an information-recording medium comprising:
a user information area in which secondary information is recorded; and
a recording block which is included in the user information area, wherein:
the recording block includes a fixed pattern which includes information about the secondary information, and the fixed pattern is inverted depending on the information about the secondary information.

In the information-recording medium according to the first aspect of the present invention, the fixed pattern may be at least one of a synchronization signal pattern and a resynchronization signal pattern.

In the information-recording medium of the present invention, the secondary information of the information recording medium is recorded not in the management information area but in the user information area. Specifically, the information about the secondary information is recorded in the fixed pattern in the recording block included in the user information area. The information about the secondary information is recorded by inverting the fixed pattern.

In this specification, the term “information about the secondary information” means not only the secondary information itself but also a part of information for constructing the secondary information. In this specification, the term “fixed pattern” refers to the specified recording pattern which is appropriately introduced in relation to the format construction of the information recording medium, and the recording pattern being based on a combination of positive and negative signs or 0 and 1 arranged irrelevant to the contents of the user data. Examples of the fixed pattern include, for example, the synchronization signal pattern, the resynchronization signal pattern, and the dummy data pattern. That is, in the case of the information-recording medium of the present invention, the information about the secondary information can be recorded irrelevant to the function and the arrangement position of the fixed pattern in the recording block.

In this specification, the term “inversion of the fixed pattern” refers to that, when the fixed pattern is formed with a wobble pattern, the phase state of the wobble pattern in the radial direction is in the opposite phase relationship (normal phase or opposite phase) depending on the information about the secondary information (“1” or “0”) recorded in the fixed pattern. When the fixed pattern is formed with an pit pattern in which pit areas and non-pit areas are formed, the term “inversion of the fixed pattern” refers to that the pit area (pit) becomes the non-pit area (flat area) and the non-pit area becomes the pit area, depending on the information about the secondary information (“1” or “0”) recorded in the fixed pattern. Further, when the fixed pattern is formed with a recording mark pattern in which recording mark areas and non-recording mark areas are formed, the term “inversion of the fixed pattern” refers to that the recording mark area (mark) becomes the non-recording mark area (no mark area) and the non-recording mark area becomes the recording mark area, depending on the information about the secondary information (“1” or “0”) recorded in the fixed pattern.

In the information-recording medium of the present invention, the fixed pattern in the user information area is inverted depending on the information in relation to the secondary information. Therefore, for example, the pattern length, the amplitude and the like of the reproduced signal obtained from the fixed pattern are completely identical irrelevant to the secondary information recorded in the fixed pattern. However, the polarity (phase) of the reproduced signal is inverted depending on the information about the secondary information included in the fixed pattern. Therefore, the information about the secondary information recorded in the fixed pattern can be reproduced by distinguishing the polarity (phase) of the obtained reproduced signal. The information inherent in the fixed pattern can be also reproduced from the reproduced signal, because the pattern length, the amplitude and the like of the reproduced signal obtained from the fixed pattern are completely identical irrelevant to the secondary information recorded in the fixed pattern. Therefore, in the case of the information-recording medium of the present invention, a part of the secondary information of the information-recording medium can be reproduced by distinguishing the polarity (phase) of the reproduced signal from the fixed pattern without deteriorating the function inherent in the fixed mark.

As described above, in the information-recording medium of the present invention, the secondary information is added to a part of the format structure of the user information area by using the fixed pattern in the user information area. Therefore, the secondary information can be read simultaneously with the user data. In the case of the information-recording medium of the present invention, the secondary information is recorded by inverting the specified fixed pattern including, for example, the fixed pattern such as the synchronization signal and the resynchronization signal depending on the information (“0” or “1”) in relation to the secondary information to be recorded in the fixed pattern. Therefore, it is difficult to distinguish the secondary information and the user information from the signal information even from the outside of the drive. Thus, it is possible to avoid the leakage of the secondary information.

In the information-recording medium of the present invention, the secondary information can be recorded in the fixed pattern including, for example, the synchronization signal pattern and the resynchronization signal pattern required to construct the format. Therefore, the area, in which the secondary information is recorded, can be simultaneously used as the area in which the synchronization signal and the resynchronization signal are recorded. Any extra area is not required to record the secondary information. When the area, in which the secondary information is recorded, is simultaneously used as the recording area for the synchronization signal and the resynchronization signal in the rewritable user data area, it is also possible to rewrite the secondary information every time when the recording is performed.

The information-recording medium according to the first aspect of the present invention may further comprise a plurality of recording blocks in the user information area, wherein the information about the secondary information is recorded with 1 bit in each of the recording blocks, and the secondary information of the information-recording medium is constructed by a set of the information about the secondary information recorded in each of the recording blocks.

In the information-recording medium according to the first aspect of the present invention, the information about the secondary information is recorded with a plurality of bits in the recording block.

According to a second aspect of the present invention, there is provided an information-recording medium comprising:
a user information area in which secondary information is recorded; and
a recording block which is included in the user information area, wherein:
the recording block includes a synchronization signal pattern which includes information about the secondary information, and the synchronization signal pattern is inverted depending on the information about the secondary information.

In the information-recording medium according to the second aspect of the present invention, the recording block may be a logical block.

In the information-recording media according to the first and second aspects of the present invention, the synchronization signal pattern may be a wobble pattern. In the information-recording media according to the first and second aspects of the present invention, the synchronization signal pattern may be a pit pattern. In the information recording media according to the first and second aspects of the present invention, the synchronization signal pattern may be a recording mark pattern.

According to a third aspect of the present invention, there is provided an information-recording medium comprising:
a user information area in which secondary information is recorded; and
a recording block which is included in the user information area, wherein:
the recording block includes a plurality of synchronization signal patterns each of which includes information about the secondary information, and each of which is inverted depending on the information about the secondary information.

In the information-recording media according to the first to third aspects of the present invention, the recording block may include an address information section, and a user information-recording section for recording information.

According to a fourth aspect of the present invention, there is provided a driving apparatus for an information-recording medium, wherein:
the information-recording medium comprises a user information area, and a recording block which is included in the user information area, wherein the recording block includes a synchronization signal pattern which includes information about secondary information of the information recording medium, and the synchronization signal pattern is inverted depending on the information about the secondary information; and
the driving apparatus comprises:
a phase-distinguishing section which distinguishes a polarity of a reproduced signal obtained from the synchronization signal pattern to reproduce the information about the secondary information corresponding to the polarity of the reproduced signal; and
a secondary information-reproducing section which reproduces the secondary information of the information recording medium on the basis of the information about the secondary information obtained by the phase-distinguishing section.

The driving apparatus according to the fourth aspect of the present invention may further comprise the information-recording medium comprising the user information area and the recording block which is included in the user information area, wherein the recording block includes the synchronization signal pattern which includes the information about the secondary information of the information-recording medium, and the synchronization signal pattern is inverted depending on the information about the secondary information.

According to a fifth aspect of the present invention, there is provided a method for recording secondary information of an information-recording medium, comprising:
generating the secondary information to be recorded on the information-recording medium including a user information area and a recording block which is included in the user information area, the recording block including a synchronization signal pattern; and
recording the secondary information of the information recording medium in the synchronization signal pattern by inverting the synchronization signal pattern depending on the generated secondary information.

According to the information-recording medium, the driving apparatus therefor, and the method for recording the secondary information of the present invention, the secondary information, which includes, for example, the information required to drive the information-recording medium, is recorded by selectively inverting the phase of the specified recording pattern (fixed pattern) in the user information area. Therefore, the secondary information can be recorded and reproduced without causing any trouble in relation to the operation of the information-recording medium.

Further, according to the information-recording medium, the driving apparatus therefor, and the method for recording the secondary information of the present invention, the management information area, which includes the secondary information necessary to drive the information-recording medium, can be also formed in the area not included in the range specified by the specification, i.e., in the user information area irrelevant to the type of the information recording medium. Therefore, the security performance is further enhanced among various information-recording media. It is possible to construct an information-recording medium system having higher reliability.

### BRIEF DESCRIPTION OF THE DRAWINGS

FIG. 1 shows a relationship between logical blocks and secondary information recorded on an optical disk according to a first embodiment corresponding to one another.

FIG. 2 shows a relationship between secondary information and synchronization signals of the optical disk according to the first embodiment corresponding to one another.

FIG. 3 schematically shows format construction of a synchronization signal area and an address information area of the optical disk according to the first embodiment.

FIG. 4 shows a schematic arrangement of a driving apparatus for reproducing secondary information from the optical disk according to the first embodiment.

FIG. 5 shows a relationship among secondary information, resynchronization signals, and synchronization signals of an optical disk according to a second embodiment corresponding to one another.

FIG. 6 schematically shows data format construction of a magnetic disk according to a third embodiment.

### DESCRIPTION OF THE PREFERRED EMBODIMENTS

The information-recording medium, the driving apparatus therefor, and the method for recording the secondary information according to the present invention will be specifically explained below as exemplified by embodiments. However, the present invention is not limited thereto.

### First Embodiment

Format Structure of Optical Disk

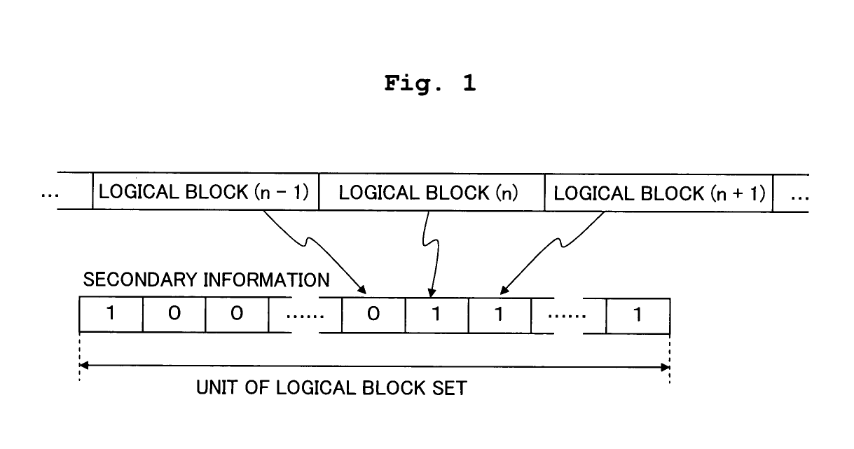

FIGS. 1 to 3 show the data format in a user information area of an optical disk manufactured in a first embodiment. As shown in the upper part of FIG. 1, the data format of the optical disk manufactured in this embodiment comprised a plurality of logical blocks (recording blocks).

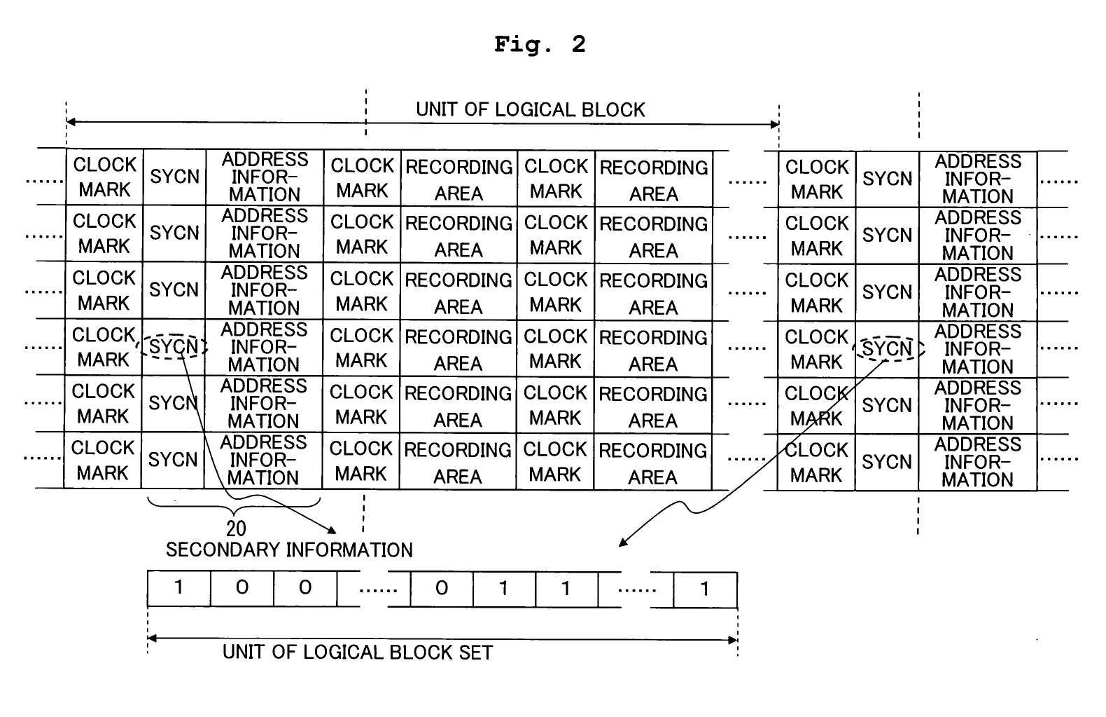

As shown in the upper part of FIG. 2, each of the logical blocks was composed of a plurality of segments. Clock marks were formed between the segments. In the case of the optical disk manufactured in this embodiment, as shown in the upper part of FIG. 2, the segment 20 (segment positioned on the leftmost side in the drawing), which is disposed at the head in the logical block, includes an area (hereinafter referred to as “SYNC area”) in which information on the synchronization signal is recorded, and an address information area. The SYNC area was provided at the position (left side in the drawing) preceding the address information area. In the case of the optical disk manufactured in this embodiment, as shown in the upper part of FIG. 2, the clock marks and the recording areas were alternately arranged after the head segment 20 in the logical block.

In the case of the optical disk manufactured in this embodiment, a part of the secondary information of the optical disk (information about the secondary information) was recorded in a synchronization signal pattern (fixed pattern) formed in the SYNC area of the head segment 20 in the logical block as described later on. That is, in this embodiment, the information in relation to the secondary information was recorded in the synchronization signal pattern in the address information section (area including the SYNC area and the address information area as shown in FIG. 2). The clock mark was provided in order to generate the clock upon the recording and reproduction of the information. The clock signal for the recording and reproduction is reproduced from the PLL circuit on the basis of the clock mark. The synchronization signal pattern, which is used to reproduce the address information recorded in the address information area, was formed in the SYNC area. The timing for reproducing the address information is obtained on the basis of the synchronization signal obtained from the synchronization signal pattern.

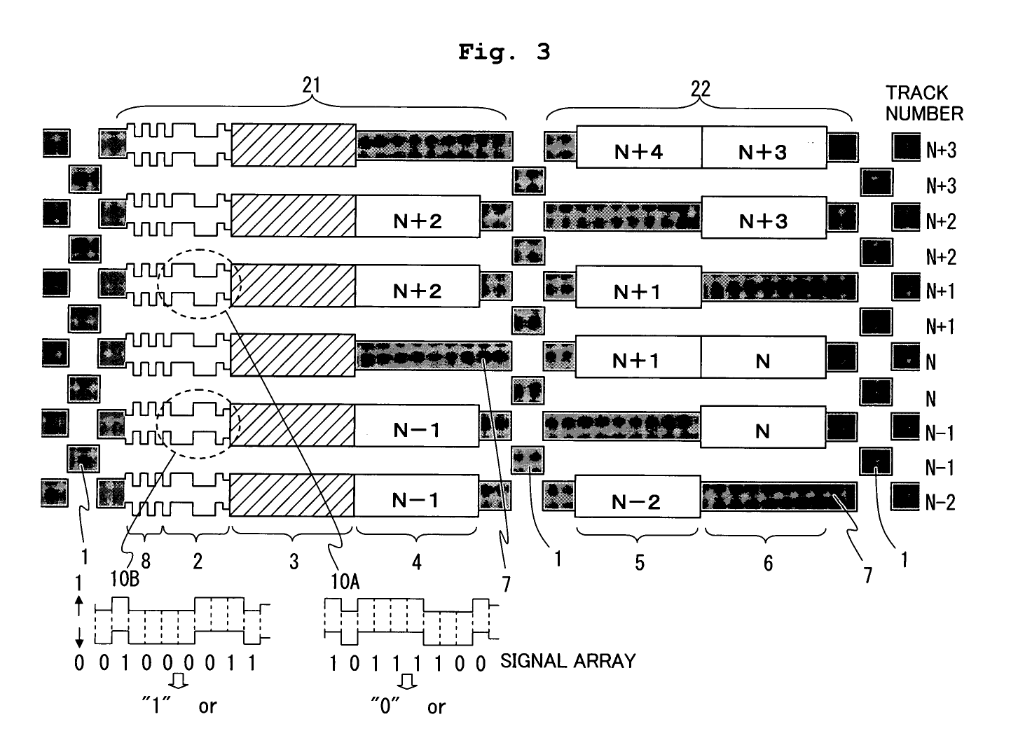

FIG. 3 shows the data format in the segment 20 arranged at the head of the logical block shown in the upper part of FIG. 2. FIG. 3 shows the data format in the segment 20 in the tracks having track numbers of N−2 to N+3 by way of example. The area 2 shown in FIG. 3 is the SYNC area, and the areas 3 to 6 are the address information areas. In this embodiment, as shown in FIG. 3, the synchronization signal pattern in the SYNC area 2 was formed with the wobble groove. For example, the address information of the physical block in the track circumference is recorded in the address information area 3 (hereinafter referred to as “in-round address information area 3” as well). For example, the address information of the track is recorded in the address information areas 4 to 6 (hereinafter referred to as “track information areas 4 to 6” as well). Each address information of the in-round address information area 3 and the track information areas 4 to 6 is recorded with the shape pattern of the wobble groove.

In the case of the optical disk manufactured in this embodiment, the segment 20, which is arranged at the head of the logical block shown in the upper part of FIG. 2, was constructed by two segments 21, 22 as shown in FIG. 3. Embedded clock marks 1 were formed between the segments 21, 22 in order to generate the recording and reproduction clock. As shown in FIG. 3, the segment 21 was composed of a preamble area 8, a SYNC area 2, an in-round address information area 3, and a track information area 4 disposed in this order from the head of the segment 21 (from the left side in the drawing). As shown in FIG. 3, the segment 22 was composed of track information areas 5 and 6 disposed in this order from the head of the segment 22.

The secondary information, which is recorded in the synchronization signal pattern in the SYNC area 2 of the optical disk manufactured in this embodiment, is the secondary information including, for example, the ID information in relation to the security, the manufacturer information, and the contents information. The secondary information is represented by bit arrays as shown in the lower part of FIG. 1 and the lower part of FIG. 2. In this embodiment, as shown in the lower part of FIG. 2, each bit information (“1” or “0”) for constructing the bit array to represent the secondary information was recorded as corresponding to the phase state (normal phase or opposite phase) in the track direction of the synchronization signal pattern (wobble pattern shown in FIG. 3) formed in the SYNC area 2 of each logical block. Therefore, in the case of the optical disk of this embodiment, as shown in FIG. 1, the information of 1 bit in relation to the secondary information is obtained from each logical block unit. As shown in the lower part of FIG. 1 and the lower part of FIG. 2, the secondary information was expressed by the predetermined set unit of 1 bit information obtained from each logical block (hereinafter referred to as “logical block set unit”).

In the case of the optical disk of this embodiment, as shown in the lower part of FIG. 3, the information “0” was allotted to a wobble pattern (normal phase state) of a synchronization signal corresponding to a binary signal array “1011110001” surrounded by a broken line 10a. Further, the information “1” was allotted to a wobble pattern (opposite phase state) of a synchronization signal corresponding to a binary signal array “10100001110” surrounded by a broken line 10B which is in the opposite phase relationship with respect to the wobble pattern of the synchronization signal surrounded by the broken line 10A. However, the present invention is not limited thereto. Reversely to the above, the wobble pattern of the synchronization signal surrounded by the broken line 10A may be designated as the information “1”, and the wobble pattern of the synchronization signal surrounded by the broken line 10B may be designated as the information “0”. In this embodiment, the 1 bit information in relation to the secondary information was recorded in the synchronization signal pattern by performing the recording by inverting the phase of the wobble pattern as described above. Therefore, when the two types of collation patterns having different polarities (positive and negative polarities) are prepared as the detection patterns for the synchronization signal pattern of the SYNC area 2, and the synchronization signal pattern detected from the SYNC area is compared with the collation pattern, then the information about the secondary information (“0” or “1”) recorded in the synchronization signal pattern of the SYNC area 2 can be reproduced with ease. The original function of the synchronization signal pattern is not deteriorated, because the individual pattern intervals for constructing the synchronization signal pattern are identical, although the phase of the synchronization signal pattern is inverted depending on the information about the secondary information to be recorded.

In the optical disk of the present invention, one round of the track has the bit array length of the logical block set unit to represent the secondary information as shown in the lower part of FIG. 2. The secondary information of 24 bits (3 bytes) was recorded on one track. The bit array length of the logical block set unit is not limited to the length described above. The length differs for each of the tracks in the optical disk, and the number of frames for constructing one track also differs depending on the track position in some cases. Therefore, it is possible to appropriately set the bit number and the length of the bit array of the logical block set unit. The logical block unit may be replaced with a periodically repeated pattern array, and the secondary information can be allotted to the pattern array to perform the recording as well. However, also in this case, it is necessary that the secondary information is recorded in the pattern array so that the information inherent in the pattern array is not deteriorated by the recording of the secondary information.

In the case of the optical disk manufactured in this embodiment, the synchronization signal pattern composed of the wobble groove as shown in FIG. 3 (for example, the patterns in the broken line areas 10A and 10B shown in FIG. 3) was formed during the process for producing the master disk. The physical address, which is used to perform the recording and reproduction on the optical disk, has such a structure that the physical address can be divided into physical block units. Therefore, the secondary information, which includes, for example, the ID information about the security and the manufacturer information, can be simultaneously recorded in the synchronization signal pattern when the physical address information is recorded during the process for producing the master disk. When the optical disk is a ROM medium, the synchronization signal pattern of the SYNC area 2 is recorded with the pit pattern. Therefore, also in this case, the secondary information is formed by the mastering process in the same manner as the synchronization signal pattern formed with the wobble groove as described above, in which the same or equivalent effect is obtained.

Driving Apparatus and Method for Reproducing Secondary Information

Next, an explanation will be made about a reproducing method and a driving apparatus for reproducing the secondary information and the synchronization signal of the optical disk from the synchronization signal pattern (wobble pattern) in the SYNC area of the optical disk manufactured in the first embodiment.

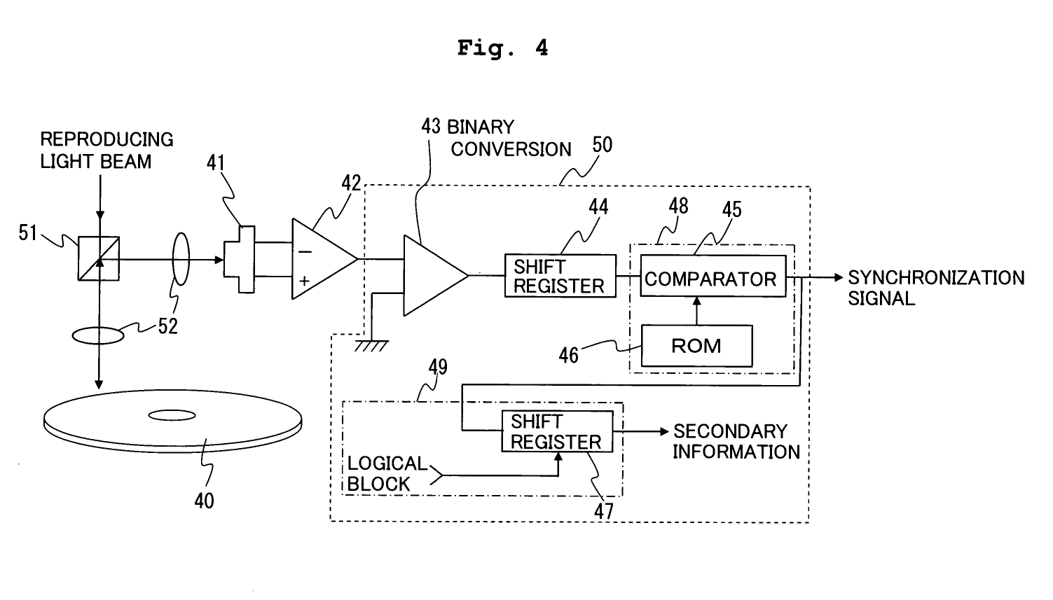

FIG. 4 shows a schematic arrangement of a secondary information-reproducing circuit section of the driving apparatus used in this embodiment. As shown in FIG. 4, the secondary information-reproducing circuit section of this embodiment principally comprises a differential amplifier 42, a binary converter 43, a first shift register 44, a phase distinguishing section 48, and a secondary information reproducing section 49. The phase-distinguishing section 48 includes a comparator 45 and ROM 46. The secondary information-reproducing section 49 principally includes a second shift register 47.

The method for reproducing the secondary information is as follows. At first, the reproducing light beam is radiated onto the wobble groove formed with the synchronization signal pattern of the optical disk 40. Subsequently, the reflected light beam, which comes from the synchronization signal pattern area (SYNC area 2 shown in FIG. 3), is detected by a two-division light-receiving element 41 via an optical system constructed, for example, by a beam splitter 51 and a light-collecting lenses 52 as shown in FIG. 4. The light-receiving element detects the change of the reflected light beam depending on the wobble direction of the wobble groove as being separated in the direction perpendicular to the track direction of the disk. Therefore, the light-receiving element is divided at least into two parts for the track direction so that the wobble signal from the wobble groove can be detected as a difference. Subsequently, the reproduced signal (for example, a differential signal such as a push-pull signal), which is detected by the two-division light-receiving element 41, is inputted into the differential amplifier 42. The output signal from the differential amplifier 42 is inputted into the binary converter 43 to output the binary information of “1” or “0” which is fed to the first shift register 44.

The binary signals, which are inputted from the binary converter 43 into the first shift register 44, are accumulated, in the logical block unit, in the first shift register 44 to generate the binary information corresponding to the synchronization signal pattern. Subsequently, the binary information of the logical block unit of the synchronization signal pattern, which is generated by the first shift register 44, is fed to the comparator 45. In the comparator 45, the binary information of the logical block unit of the synchronization signal pattern is compared with the binary information of the synchronization signal pattern of the normal phase or the opposite phase stored in ROM 46 to generate the synchronization signal. Further, it is judged whether the reproduced signal of the detected synchronization signal pattern has the normal phase or the opposite phase. If the binary information of the logical block unit of the synchronization signal pattern generated by the first shift register 44 is judged to have the normal phase, the 1 bit information “0” is outputted to the second shift register 47. If the binary information of the logical block unit of the synchronization signal pattern generated by the first shift register 44 is judged to have the opposite phase, the 1 bit information “1” is outputted to the second shift register 47. The second shift register 47 accumulates, in the logical block set unit, the binary information in the logical block unit outputted from the first shift register 44 to generate the bit array which expresses the secondary information of the optical disk as shown in the lower part of FIG. 2. The secondary information is reproduced from the bit array in the logical block set unit generated by the second shift register

When the driving apparatus and the reproducing method for the optical disk as described above are used, the secondary information of the optical disk has been successfully recorded and reproduced without causing any trouble in the recording and reproducing operation for the information (for example, the user information) other than the secondary information of the optical disk.

### Second Embodiment

The data format in the user information area of an optical disk manufactured in a second embodiment comprised a plurality of logical blocks (recording blocks) as shown in the upper part of FIG. 1. The optical disk of this embodiment was a rewritable optical disk.

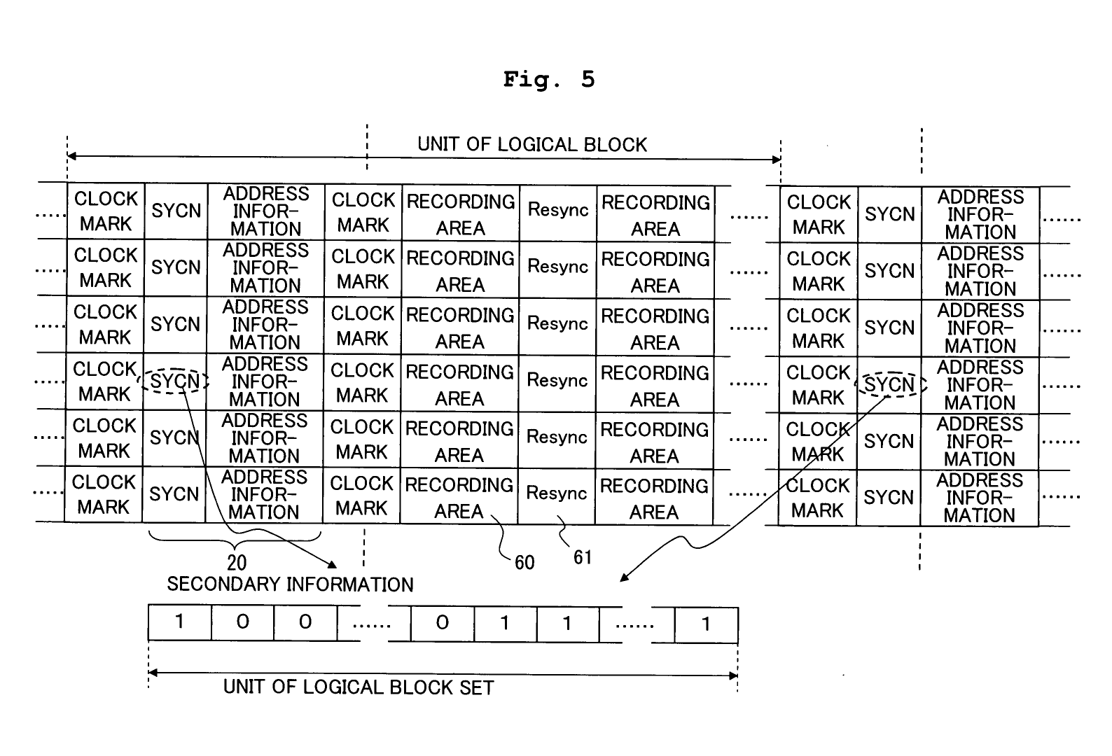

FIG. 5 shows a schematic arrangement of the data format of each logical block of the optical disk of this embodiment. As shown in the upper part of FIG. 5, each logical block of the optical disk of this embodiment includes a plurality of segments. In the case of the optical disk manufactured in this embodiment, as shown in the upper part of FIG. 5, the segment 20 (segment positioned on the leftmost side in the drawing), which is disposed at the head in the logical block, includes a SYNC area in which information about the synchronization signal is recorded, and an address information area. The SYNC area was provided at the position (left side in the drawing) preceding the address information area. In this embodiment, the segment 20 disposed at the head in the logical block has the same structure as that of the first embodiment (structure shown in FIG. 3). That is, in this embodiment, the synchronization signal pattern of the SYNC area was formed with the wobble pattern in the same manner as in the first embodiment.

In the optical disk of this embodiment, as shown in the upper part of FIG. 5, a resynchronization signal area 61 (hereinafter referred to as “Resync area” as well) was provided between recording areas 60 in which the user information is recorded. The synchronization signal, which was recorded in the Resync area 61, was recorded as a recording mark pattern when the user data was recorded. That is, in the case of the optical disk of this embodiment, the synchronization signal pattern in the SYNC area is formed by the mastering process, while the resynchronization signal pattern in the Resync area 61 is formed when the user data is recorded. When the optical disk is a ROM medium, the resynchronization signal pattern in the Resync area 61 is formed with a pit pattern, which is formed by the mastering process in the same manner as the synchronization signal pattern in the SYNC area.

In the case of the optical disk of this embodiment, as shown in FIG. 5, the 1 bit information (“0”, or “1”) for constructing the secondary information was recorded in the synchronization signal pattern in the SYNC area and the resynchronization signal pattern in the Resync area respectively. That is, in this embodiment, the information about the secondary information was recorded in the address information section and the user information-recording section for recording information (area including the Resync area and the recording area shown in FIG. 5). Therefore, in this embodiment, the information in relation to the secondary information is recorded with a plurality of bits in one logical block. The following method was adopted to record the secondary information in the synchronization signal pattern in the SYNC area and the resynchronization signal pattern in the Resync area. That is, the recording was performed by inverting the synchronization signal pattern depending on the information (“0” or “1”) about the secondary information to be recorded in the synchronization signal pattern as explained in the first embodiment. Specifically, as for the synchronization signal pattern in the SYNC area, the phase in the track direction of the wobble pattern was inverted depending on the information about the secondary information to be recorded. As for the resynchronization signal pattern in the Resync area, the recording mark area and the non-recording mark area were formed in an opposite pattern depending on the information about the secondary information to be recorded.

When the secondary information is arranged in the logical block as described above, it is possible to independently add the secondary information to the SYNC area for the address information and the Resync area provided in the user data area (between the recording areas in FIG. 5) respectively. Of course, it is also allowable that the secondary information is recorded in only the Resync area to record the secondary information relating to the user data.

When the secondary information recorded on the optical disk of this embodiment is reproduced, the recorded 1 bit information in relation to the secondary information is reproduced separately for the SYNC area and the Resync area of the optical disk respectively in the same manner as in the first embodiment. The obtained 1 bit information in relation to the secondary information is arranged to provide a predetermined data array as shown in the lower part of FIG. 5. Thus, it is possible to reproduce the secondary information.

In the procedure described above, the secondary information included in the SYNC area (hereinafter referred to as “preformat secondary information” as well) and the secondary information included in the Resync area (hereinafter referred to as “write-once or rewritable secondary information” as well) were recorded as distinct pieces of information (independent pieces of information). However, the present invention is not limited thereto. The recording system for the secondary information as shown in FIG. 3 is effective for a system in which the rewritable secondary information is added to the preformat secondary information, i.e., a system in which the preformat secondary information and the rewritable secondary information are reproduced separately, and the reproduced pieces of the secondary information are correlated with each other to record the secondary information. In this recording system, the rewritable secondary information can be handled as the information which relates to the preformat secondary information. For example, in this case, the combination of the preformat secondary information and the rewritable secondary information can be recorded one piece of information. Therefore, the recording and reproduction of the user data can be restricted for any information-recording medium in which the correlation between the preformat secondary information and the rewritable secondary information is not justified. Therefore, when the secondary information is recorded in accordance with the system in which the rewritable secondary information is added to the preformat secondary information as described above, it is possible to avoid, for example, the illegal copy of the medium more effectively.

An explanation will now be made more specifically about the system for adding the rewritable secondary information to the preformat secondary information. For example, a system is assumed, in which the user data or the like cannot be recorded and reproduced if the preformat secondary information and the rewritable secondary information cannot be correlated with each other. The preformat secondary information is the information which is fixed at the production stage and which is the information inherent in the medium. On the other hand, the rewritable secondary information is the secondary information which is newly added when the user data is recorded. Therefore, the rewritable secondary information can be freely recorded. However, in the system discussed herein, the recording of the information correlated with the preformat information inherent in the medium as the rewritable secondary information (for example, the same secondary information as the preformat secondary information) is the proof of the justified recording on the specified medium. The rewritable secondary information cannot be recorded with the drive which cannot read the preformat secondary information. That is, when the preformat secondary information and the rewritable secondary information are recorded while being correlated with each other, the rewritable secondary information can be recorded in a conditioned manner corresponding to the preformat secondary information which differs for every medium. When the recording method for the secondary information as described above is used, it is possible to restrict the reproduction of the user data, even if any drive capable of recording the rewritable secondary information is available, provided that the preformat secondary information is not correlated with the rewritable secondary information (for example, provided that the preformat secondary information is not coincident with the rewritable secondary information). The method for correlating the preformat secondary information and the rewritable secondary information is not limited to the example described above, which can be appropriately designed depending on the way of use including, for example, the recording of the operation result for the purpose of security.

### Third Embodiment

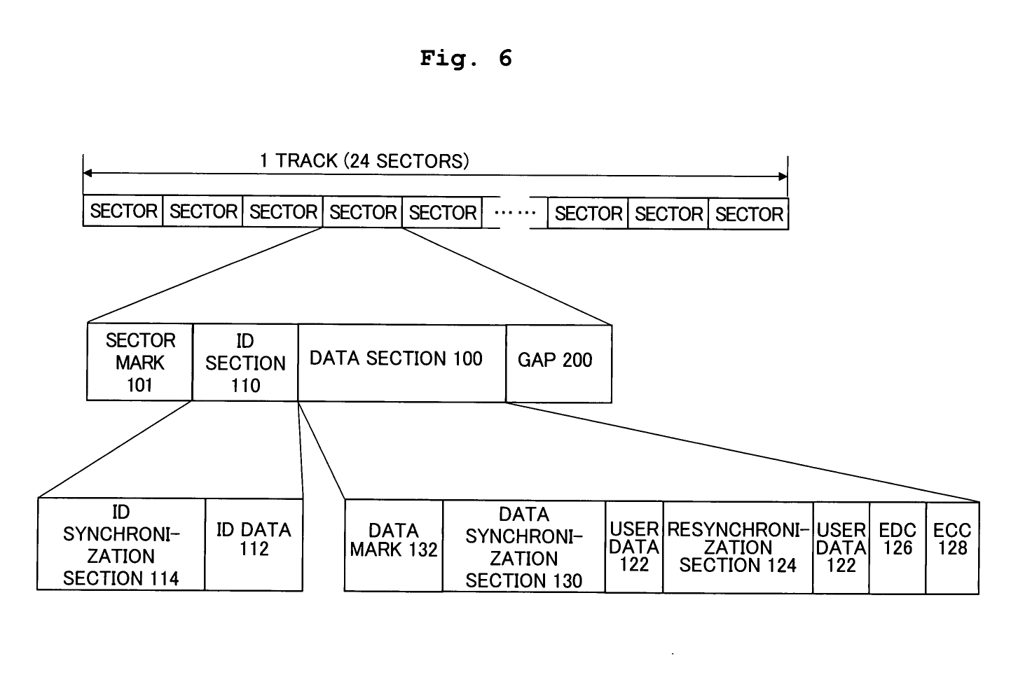

In a third embodiment, an explanation will be made about an example in which the system for recording the secondary information according to the present invention is applied to a magnetic disk. FIG. 6 shows a schematic arrangement of the data format of a user information area of the magnetic disk manufactured in this embodiment. As shown in the upper part of FIG. 6, the user information area of the magnetic disk of this embodiment is subjected to the recording while being divided into sector units (logical block units). In this embodiment, 1 track was composed of 24 sectors. In this embodiment, 1 bit information for constructing the secondary information was allotted for each of the sectors. In this embodiment, it is assumed that the secondary information is recorded in the sector set unit, and the logical information block is constructed by accumulating a plurality of sectors, in the same manner as in the first embodiment (arrangement shown in FIG. 1). For example, when one round of the track of the magnetic disk is the logical block set unit, the secondary information is recorded with the number of logical blocks for constructing 1 track. When the logical block (sector) is expressed as the frame, the secondary information of 24 bits, i.e., 3 bytes can be recorded with the format in which 1 track is constructed by 24 frames as in the magnetic disk of this embodiment.

Schematic block diagrams in the sector of the magnetic disk of this embodiment are shown in the middle part and the lower part of FIG. 6. As shown in the middle part of FIG. 6, the sector (recording block) of the magnetic disk of this embodiment comprises a sector mark 101, an ID section 110 (address information section), a data (Data) section 100 (user information-recording section), and a gap (Gap) 200. The sector mark 101, the ID section 110, the data section 100, and the gap 200 are arranged in this order from the forward end side of the sector (from the left side in FIG. 6). As shown in the lower part of FIG. 6, the ID section 100 comprises an ID data 112 and an ID synchronization section (ID Sync) 114. The data section 100 comprises a user data 122, a resynchronization section (Resync) 124, an error detection code (EDC) 126, and an error correction code (ECC) 128. It is assumed that the magnetic head, which is driven when the information is recorded and reproduced on the magnetic disk of this embodiment, is driven from the left to the right for the sector as viewed in FIG. 6.

The ID synchronization section 114 is a reading trigger for a hardware (for example, a PLL circuit) in order to find out the ID mark. The ID section 110 may possess EDC or a cyclic redundant check code (CRCC) which is similar in function to EDC. In the ID data 112, ID of the corresponding sector (sector including the ID data 112) is recorded and ID data 112 has, for example, a size of 7 bytes.

The user data 122 is a predetermined data area in which the user can perform the recording and reproduction. The resynchronization section 124 functions as a reading trigger for EDC. EDC 126 detects whether or not the user data 122 is correct, but EDC 126 does not correct the error. ECC 128 can correct the error of the ID data 112 and the user data 122 to restore the original data. The gap 200 is inserted as a kind of buffer for absorbing the interference between the sectors in order that the length is adjusted.

As shown in the lower part of FIG. 6, the sector preferably includes a data synchronization section (Data Sync) 130 and a data mark (Data Mark) 132 before the user data 122 of the data section 100 (forward end of the data section 100). The data synchronization section 130 is a reading trigger for a hardware (for example, a PLL circuit) in order to find out the data mark 132. The data mark 132 is provided in order to identify the data section 100.

As described above, the sector of the magnetic disk of this embodiment has the resynchronization section 124 as shown in the lower part of FIG. 6. The resynchronization section 124 is a reading trigger for a hardware (for example, a PLL circuit) to communicate the fact that EDC 126 is read by performing the synchronization in response to a specified signal when any error arises in the user data 122. The magnetic head of the unillustrated driving apparatus is moved in the forward direction (direction from the left to the right in the lower part of FIG. 6) after reading the resynchronization section 124 to read EDC 126. Therefore, the resynchronization section 124 is arranged at the position preceding EDC 126.

A resynchronization signal pattern, which is formed in the resynchronization section 124, is formed with a repeating pattern having an identical frequency, which is constructed by such a pattern that the same information as that of the original pattern is obtained even when the phase of the pattern is inverted. Therefore, in the case of the magnetic disk of this embodiment, the secondary information was recorded in the resynchronization signal pattern formed in the resynchronization section 124. For example, the information “1” concerning the secondary information is allotted as an inverted resynchronization signal pattern (opposite phase pattern), and the information “1” concerning the secondary information is allotted as a resynchronization signal pattern (or a normal phase pattern) which is not inverted. Accordingly, the information about the secondary information can be recorded in the resynchronization signal pattern of the resynchronization section 124. The phase relationship between the information about the secondary information and the resynchronization signal pattern of the resynchronization section 124 may be designated to correspond oppositely to the above.

When the information about the secondary information is recorded in the resynchronization signal pattern of the resynchronization section 124, the secondary information can be simultaneously recorded (the synchronization signal pattern is allowed to have the normal phase or the opposite phase) when the user data is rewritten. Therefore, the resynchronization section 124 is preferably usable as the secondary information-recording section which is utilized when the user applies the security to the private data. Also in this embodiment, the information about the secondary information may be recorded in the synchronization signal pattern formed in the data synchronization section 130 and/or the ID synchronization section in the same manner as in the first embodiment. Alternatively, the information about the secondary information may be recorded mutually independently in the synchronization signal pattern in the resynchronization section 124, the data synchronization section 130, and the ID synchronization section 114 in the same manner as in the second embodiment.

Next, an explanation will be made about a method for recording and reproducing the secondary information on the resynchronization section 124 of the data section 100 of the magnetic disk of this embodiment. In this embodiment, the security data, which is used to apply the security to the data intended to be recorded by the user, was recorded as the secondary information in the resynchronization section 124.

At first, the encoded security data was generated by combining the pattern of “1” and “0” by using a security data-generating section (not shown). In this operation, the security data of 3 bytes was generated in this embodiment. Subsequently, the generated security data was subjected to the pattern modulation on the basis of the security data to be recorded by using a resynchronization signal-generating section (not shown) (the resynchronization signal pattern of the resynchronization section 124 was appropriately inverted on the basis of the security data to be recorded). Subsequently, the pattern-modulated security data is arranged as the data array of the resynchronization signal to be recorded on the magnetic disk in the resynchronization section 124 of each of the sectors, and the data is recorded on the magnetic disk. In this embodiment, 1 track of the magnetic disk comprised 24 sectors. Therefore, the 1 bit security data was allotted to one resynchronization section 124 in each of the sectors. In this way, the secondary information of 3 bytes was recorded in a form of being embedded in the resynchronization signal of 1 track.

On the other hand, when the security data included in the resynchronization section 124 of the data section 100 is reproduced from the resynchronization signal, the resynchronization signal of the resynchronization section 124 is firstly detected by the magnetic head (not shown). The resynchronization signal is generated, and the 1 bit information (“0” or “1”) concerning the security data, which is embedded in the resynchronization signal, is decoded by distinguishing the pattern of the resynchronization signal (distinguishing the polarity). The information of 1 bit about the security data decoded from the respective sectors are arranged in a predetermined sequence to reproduce the security data.

The operation, which is performed after detecting the resynchronization signal of the resynchronization section 124 by using the magnetic head in the procedure for reproducing the secondary information from the resynchronization section 124 of the magnetic disk of this embodiment, is executed in the same manner as in the case in which the secondary information is reproduced from the resynchronization signal pattern explained for the optical disk of each of the first and second embodiments. That is, the magnetic head is used to detect the resynchronization signal from the resynchronization section 124 in the case of the driving apparatus for reproducing the secondary information from the resynchronization signal pattern of the resynchronization section 124 of the magnetic disk of this embodiment. However, the same processing as that used in each of the first and second embodiments is performed as the signal processing after obtaining the binary signal from the resynchronization signal. Therefore, in the case of the driving apparatus for reproducing the secondary information from the magnetic disk of this embodiment, the apparatus construction after the binary converter 43 shown in FIG. 4 (apparatus construction of the portion surrounded by the broken line 50 shown in FIG. 4) is identical.

As described above, in the case of the magnetic disk of this embodiment, the secondary information was recorded by phase-inverting and modulating the resynchronization signal pattern of the resynchronization section. Therefore, the secondary information had been successfully recorded and reproduced without exerting any influence on the recording and reproduction of the user data.

In recent years, it has been tried to increase the recording capacity by narrowing the track pitch in the field of the hard disk as well, in which it is also possible to previously provide grooves necessary for the tracking and record the address with a concave/convex pattern in the same manner as in the optical disk. When the groove-shaped difference in height is provided for the recording film as described above, an effect is obtained, for example, such that the magnetic interference between tracks adjoining each other is reduced to increase the recording density.

The recording system for the secondary information of the present invention is also applicable to the magnetic recording medium having the synchronization signal pattern previously formed with the concave/convex pattern as described above. In this case, the secondary information can be recorded with a fine pattern by making full use of the optical disk production techniques. Of course, the recording system for the secondary information of the present invention also assumes that the secondary information is recorded not only with the concave/convex pattern as described above but also with the resynchronization signal pattern and the synchronization signal pattern recorded as magnetic domains. In this case, the secondary information in relation to the user information can be recorded concurrently with the recording of the user information.

The first to third embodiments described above have been explained as exemplified by the case in which the secondary information is recorded in the synchronization signal pattern and/or the resynchronization signal pattern. However, the present invention is not limited thereto. The secondary information may be recorded in a dummy data pattern in the recording block. Alternatively, the secondary information may be recorded in a specified data array in the user data.

The first to third embodiments described above have been explained as exemplified by the information-recording medium in which one secondary information is recorded over a plurality of recording blocks (logical blocks or sectors). However, the present invention is not limited thereto. For example, one secondary information may be recorded in one recording block. In this case, the information about the secondary information may be recorded with 1 bit in each of fixed patterns (for example, the synchronization signal pattern, the resynchronization signal pattern, the dummy data pattern and the like) having the same number as that of the number of bits of the secondary information in the recording block.

As described above, according to the information recording medium, the driving apparatus therefor, and the method for recording the secondary information concerning the present invention, the management information area including the management information necessary for driving the information-recording medium can be also formed in the portion without the range specified by the specification, for example, in the user information area, irrelevant to the type of the information-recording medium. Therefore, the security performance is further enhanced among various of information recording media, and it is possible to construct the information-recording medium system having higher reliability.

The ROM medium is the medium on which the user information is recorded during the mastering. Therefore, in the case of the ROM medium, it is necessary that the secondary information about the security should be recorded by using such a technique that no forgery is made easily during the recording of the user information (during the mastering). Therefore, the method for recording the secondary information, which is based on the preformat secondary information of the present invention, is effective for the ROM medium.

What is claimed is:

1. An information-recording medium comprising:
a user information area in which secondary information is recorded; and
a recording block which is included in the user information area, wherein:
the recording block includes a fixed pattern which includes information about the secondary information, and the fixed pattern is inverted depending on the information about the secondary information.

2. The information-recording medium according to claim 1, wherein the fixed pattern is at least one of a synchronization signal pattern and a resynchronization signal pattern.

3. The information-recording medium according to claim 1, further comprising a plurality of recording blocks in the user information area, wherein the information about the secondary information is recorded with 1 bit in each of the recording blocks, and the secondary information of the information-recording medium is constructed by a set of the information about the secondary information recorded in each of the recording blocks.

4. The information-recording medium according to claim 1, wherein the information about the secondary information is recorded with a plurality of bits in the recording block.

5. The information-recording medium according to claim 2, wherein the synchronization signal pattern is a wobble pattern.

6. The information-recording medium according to claim 2, wherein the synchronization signal pattern is a pit pattern.

7. The information-recording medium according to claim 2, wherein the synchronization signal pattern is a recording mark pattern.

8. The information-recording medium according to claim 1, wherein the recording block includes an address information section, and a user information-recording section for recording information.

9. An information-recording medium comprising:
a user information area in which secondary information is recorded; and
a recording block which is included in the user information area, wherein:
the recording block includes a synchronization signal pattern which includes information about the secondary information, and the synchronization signal pattern is inverted depending on the information about the secondary information.

10. The information-recording medium according to claim 9, wherein the recording block is a logical block.

11. The information-recording medium according to claim 9, further comprising a plurality of recording blocks in the user information area, wherein the information about the secondary information is recorded with 1 bit in each of the recording blocks, and the secondary information of the information-recording medium is constructed by a set of the information about the secondary information recorded in each of the recording blocks.

12. The information-recording medium according to claim 9, wherein the synchronization signal pattern is a wobble pattern.

13. The information-recording medium according to claim 9, wherein the synchronization signal pattern is a pit pattern.

14. The information-recording medium according to claim 9, wherein the synchronization signal pattern is a recording mark pattern.

15. An information-recording medium comprising:
a user information area in which secondary information is recorded; and
a recording block which is included in the user information area, wherein:
the recording block includes a plurality of synchronization signal patterns each of which includes information about the secondary information, and each of which is inverted depending on the information about the secondary information.

16. The information-recording medium according to claim 15, wherein the information about the secondary information is recorded with a plurality of bits in the recording block.

17. A driving apparatus for an information-recording medium, wherein:
the information-recording medium comprises a user information area, and a recording block which is included in the user information area, wherein the recording block includes a synchronization signal pattern which includes information about secondary information of the information recording medium, and the synchronization signal pattern is inverted depending on the information about the secondary information; and
the driving apparatus comprises:
a phase-distinguishing section which distinguishes a polarity of a reproduced signal obtained from the synchronization signal pattern to reproduce the information about the secondary information corresponding to the polarity of the reproduced signal; and
a secondary information-reproducing section which reproduces the secondary information of the information recording medium on the basis of the information about the secondary information obtained by the phase-distinguishing section.

18. The driving apparatus for the information-recording medium according to claim 17, wherein the driving apparatus further comprises the information-recording medium comprising the user information area and the recording block which is included in the user information area, wherein the recording block includes the synchronization signal pattern which includes the information about the secondary information of the information-recording medium, and the synchronization signal pattern is inverted depending on the information about the secondary information.

19. A method for recording secondary information of an information-recording medium, comprising:
generating the secondary information to be recorded on the information-recording medium including a user information area and a recording block which is included in the user information area, the recording block including a synchronization signal pattern; and
recording the secondary information of the information recording medium in the synchronization signal pattern by inverting the synchronization signal pattern depending on the generated secondary information.
